(19) United States
(12) Patent Application Publication
(10) Pub. No.: US 2025/0100627 A1
(43) Pub. Date: Mar. 27, 2025

(54) VEHICLE BODY ASSEMBLY

(71) Applicants: HYUNDAI MOTOR COMPANY, Seoul (KR); KIA CORPORATION, Seoul (KR)

(72) Inventors: Won Hae Lee, Seoul (KR); Chang Kyu Kim, Hwaseong-si (KR); Seung Min Jeong, Hwaseong-si (KR); Byung Joo Chung, Gunpo-si (KR); Seung Hak Lee, Asan-si (KR); Mi Ran Park, Hwaseong-si (KR)

(73) Assignees: HYUNDAI MOTOR COMPANY, Seoul (KR); KIA CORPORATION, Seoul (KR)

(21) Appl. No.: 18/609,969

(22) Filed: Mar. 19, 2024

(30) Foreign Application Priority Data
Sep. 25, 2023 (KR) 10-2023-0128474

(51) Int. Cl. B62D 25/20; B60K 1/04

(52) U.S. Cl. CPC B62D 25/2009; B60K 2001/0405

(57) ABSTRACT

A vehicle body assembly includes a cross member configured to connect side members disposed at two opposite sides of a chassis frame of a vehicle. A battery is fastened to the cross member and the battery is fastened to a reinforcement member provided on a floor panel of a vehicle body and fastened to the cross member of the chassis frame. The battery may be installed in and removed from the vehicle in accordance with a user's needs that change even after the vehicle is manufactured, the battery of the vehicle may be replaced even after the vehicle is manufactured, and structural durability may be realized.

### CROSS-REFERENCE TO RELATED APPLICATION

The present application claims priority to Korean Patent Application No. 10-2023-0128474, filed on Sep. 25, 2023, the entire contents of which are incorporated herein for all purposes by this reference.

### BACKGROUND

### Field of the Disclosure

The present disclosure relates to a vehicle body assembly for a vehicle that is equipped with a replaceable battery system and that includes a vehicle body with a chassis frame having a cross member to which a single battery or a plurality of batteries is fastened and with a reinforcement member fastened to the cross member.

### Description of the Related Art

Recently, there has been an increasing demand for electric vehicles because of environmental issues. However, it is essential to charge batteries of the electric vehicles. Thus, the adoption of electric vehicles may be limited in areas where infrastructure for charging the batteries cannot be provided or is not available.

There is also a problem in that it is difficult to cope with a situation in which a necessary traveling distance or a necessary loading weight needs to be increased because of a change in the needs of a vehicle user as the vehicle is used compared to when the vehicle was initially acquired.

It is also difficult for transportation operators to use electric vehicles for the transportation business because transportation efficiency is decreased by a relatively large amount of battery charging time.

Therefore, recently, methods of replacing the battery installed in an electric vehicle has been considered in addition to methods of charging the battery installed in the vehicle. However, the typical battery may be used only in a state in which the battery is initially mounted and fixed in the electric vehicle by the manufacturer. For this reason, it may be difficult to replace the battery that was installed at the time of manufacturing the typical vehicle.

The foregoing is provided as the background and is intended merely to aid in understanding the background of the present disclosure. The foregoing is not intended to mean that the present disclosure falls within the purview of the related art that is already known to those of ordinary skill in the art.

### SUMMARY

The present disclosure proposes to solve these problems. The present disclosure aims to provide a vehicle body assembly capable of: defining an installation space in which a battery is installed by a cross member and a side member that are adjacent to each other; disposing a connector in the installation space to enable a battery to be replaced even after a vehicle is manufactured; and installing the battery in the entirety or a part of the installation space, as necessary, to cope with or accommodate a user's needs that may change over time.

The present disclosure also aims to provide a vehicle body assembly capable of: simplifying a structure of a vehicle by means of a connection line introduced through an outermost peripheral cross member; protecting the connection line and supporting the cross member by use of a rail fastened to the cross member; and improving rigidity of a chassis frame by use of a reinforcement member.

Technical problems to be solved by the present disclosure are not limited to the above-mentioned technical problems. Other technical problems, which are not mentioned above, may be more clearly understood from the following description by those of ordinary skill in the art to which the present disclosure pertains.

In order to achieve the above-mentioned object, the present disclosure provides a vehicle body assembly for a vehicle. The vehicle body assembly includes a chassis frame and a vehicle body. The chassis frame includes side members disposed at two opposite sides of the vehicle body and configured to connect front side members and rear side members. The chassis frame also includes a single cross member or a plurality of cross members configured to connect the side members and a single battery or a plurality of batteries being fastened to the single cross member or the plurality of cross members. The vehicle body is configured to define an interior space of a vehicle and is coupled to an upper portion of the chassis frame. The vehicle body includes a floor panel provided on a bottom surface thereof and a single reinforcement member or a plurality of reinforcement members provided on the floor panel thereof and extending in a length direction of the vehicle. The reinforcement member is fastened to the single cross member or the plurality of cross members.

For example, a plurality of cross members may be disposed to be spaced apart from one another in the length direction of the vehicle body assembly. A pair of the cross members adjacent to the side members may define an installation space. The installation space may be provided as a plurality of installation spaces formed in the length direction of the vehicle body assembly. TBatteries may be respectively inserted into the installation spaces and fastened to the cross members.

For example, the plurality of cross members may be spaced apart from one another at equal distances. The plurality of installation spaces may be formed to have the same shape and the plurality of batteries may be formed to have the same shape.

The vehicle body assembly of the present disclosure may further include rails extending in the length direction of the vehicle body assembly. The rails may be fastened to and supported by the one or more cross members and may be configured to protect a connection line by covering the connection line, which may include a cable or hose connected to the battery or batteries.

For example, the rails may be provided as a pair of rails spaced apart from each other. A protection space may be formed between the pair of rails and the connection line may be disposed in the protection space.

The vehicle body assembly of the present disclosure may further include a connector or connectors installed on the rails or the cross member or cross members and having one side connected to the connection line and the other side connected to the battery or batteries.

For example, the vehicle body assembly may further include a connector or connectors provided in a protection space between the pair of rails and having one side connected to the connection line and the other side connected to the battery or batteries.

For example, a battery connection part may be formed at the other side of the connector, and the battery connection part may be directed downward so that a battery is fastened to the connector in a direction from a lower side toward an upper side.

For example, a connectors may be disposed for each of the installation spaces. Sets of the connection lines may be introduced through a cross member at an outermost periphery, and the sets of connection lines may each extend along the rails and be connected to the corresponding connector.

For example, the rails may extend along the connection lines from a cross member at the outermost periphery, through which the connection lines are introduced, to a point at which the last connector is disposed.

In the vehicle body assembly of the present disclosure, a pair of brackets, each having a fastening mechanism, may be provided on two opposite surfaces of a battery directed toward the adjacent cross member. One of the pair of brackets may have a pin inserted into the cross member.

For example, brackets having the pins may be disposed on two opposite sides of a battery and may be disposed in a staggered manner.

For example, a pin may be disposed on the battery, a hole may be formed in the adjacent cross member, and an end of the pin may be exposed to an upper end of the cross member in a state in which the pin penetrates the cross member.

In the vehicle body assembly of the present disclosure, each cross member may be fastened to the reinforcement member by means of a corresponding penetration bolt that penetrates the cross member in an upward/downward direction.

For example, each cross member may be fastened to the reinforcement member by means of the penetration bolts. The penetration bolts may be provided at two opposite sides of the rails with the rails interposed therebetween.

According to the present disclosure, a battery may be replaced within a short time in comparison with a comparatively long time period required for battery charging, thereby using time more efficiently.

In addition, a driver may adjust the number of battery blocks in consideration of a necessary traveling distance and a necessary loading weight, thereby using the vehicle in a multipurpose manner. Therefore, it is possible to adjust the traveling distance and the loading weight that may be required to shorten or accommodate charging time.

Further, it is possible to realize structural durability by means of the single cross member or the plurality of cross members that connect the side members disposed at two opposite sides of the vehicle. The single cross member or the plurality of cross members, which connect the side members disposed at the two opposite sides, may be fastened to the reinforcement member provided on the floor panel of the vehicle body, thereby additionally enhancing structural durability.

### BRIEF DESCRIPTION OF THE DRAWINGS

FIG. 1 is a view illustrating a chassis frame according to an embodiment of the present disclosure.

FIG. 2 is a view illustrating a state in which a battery is fastened to a vehicle body when viewed from the bottom side.

FIG. 3 is a view illustrating a state in which a vehicle body and a chassis frame according to the embodiment of the present disclosure are fastened.

FIG. 4 is a view illustrating a battery according to the embodiment of the present disclosure.

FIG. 5 is a view illustrating a state in which a battery is installed on a chassis frame according to the embodiment of the present disclosure when viewed from the bottom side.

FIG. 6 is a view illustrating a cross-section of a cross member to which a battery according to the embodiment of the present disclosure is fastened.

FIG. 7 is a view illustrating a cross-section of a cross member fastened to a reinforcement member by a penetration bolt according to the embodiment of the present disclosure.

### DETAILED DESCRIPTION

Hereinafter, embodiments disclosed in the present specification are described in detail with reference to the accompanying drawings. The same or similar constituent elements are assigned with the same reference numerals throughout the drawings, and the repetitive descriptions thereof have been be omitted.

In the description of the embodiments disclosed in the present specification, the specific descriptions of publicly known related technologies have been omitted where it has been determined that the specific descriptions may obscure the subject matter of the embodiments disclosed in the present specification. In addition, it should be interpreted that the accompanying drawings are provided only to allow those of ordinary skill in the art to easily understand the embodiments disclosed in the present specification. The technical concepts disclosed in the present specification are not limited by the accompanying drawings, and include all alterations, equivalents, and alternatives that are included within the spirit and the technical scope of the present disclosure.

Singular expressions include plural expressions unless clearly described as having different meanings in context.

In the present specification, it should be understood that the terms “comprises,” “comprising,” “includes,” “including,” “containing,” “has,” “having” or other variations thereof are inclusive. Therefore, such terms specify the presence of stated features, integers, steps, operations, elements, components, or combinations thereof, but do not preclude the presence or addition of one or more other features, integers, steps, operations, elements, components, or combinations thereof.

The suffixes “module”, “unit”, “part”, and “portion” used to describe constituent elements in the following description are used together or interchangeably in order to facilitate the description. The suffixes themselves do not have distinguishable meanings or functions.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

The present disclosure defines an installation space in which a battery is installed by means of a cross member and a side member that are adjacent to each other. A connector is disposed in the installation space in order to enable a battery to be secured and replaced even after a vehicle is manufactured. Therefore, it is possible for a driver to adjust the number of battery blocks in consideration of a necessary traveling distance and a necessary loading weight. This may help to ensure a short charging time and a necessary traveling distance and adjust a loading weight to cope with a user's needs, which may change.

In addition, it is possible to realize or enhance structural durability by means of a single cross member or a plurality of cross members that connect side members disposed at two opposite sides of the chassis frame. The single cross member or the plurality of cross members, which connect the side members disposed at the two opposite sides, may be fastened to a reinforcement member provided on a floor panel of a vehicle body, thereby additionally enhancing structural durability.

Meanwhile, the present disclosure aims to provide a vehicle body assembly capable of simplifying a structure of a vehicle by a connection line introduced through an outermost peripheral cross member. The body assembly is also capable of protecting the connection line and supporting the cross member by means of a rail fastened to the cross member and of improving rigidity of a chassis frame by use of a reinforcement member.

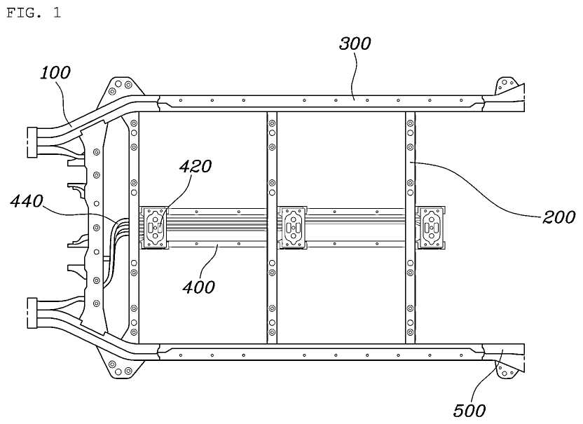

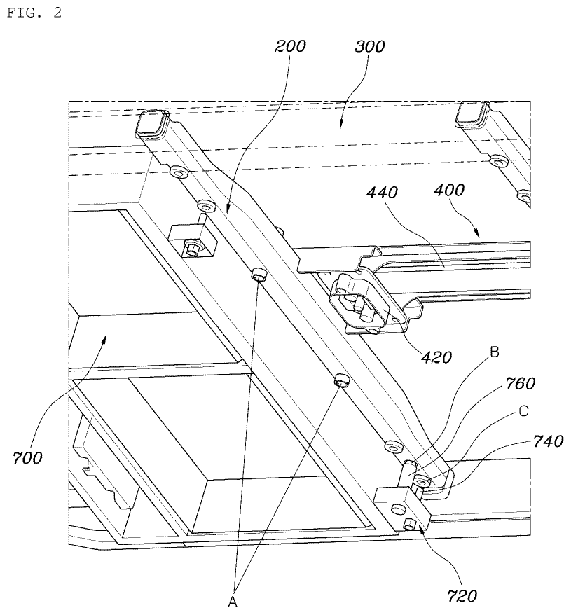

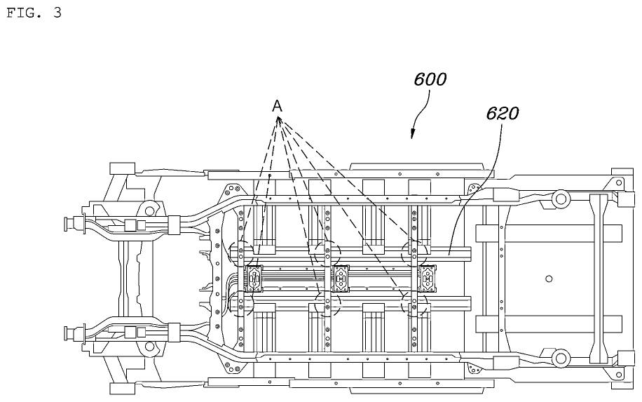

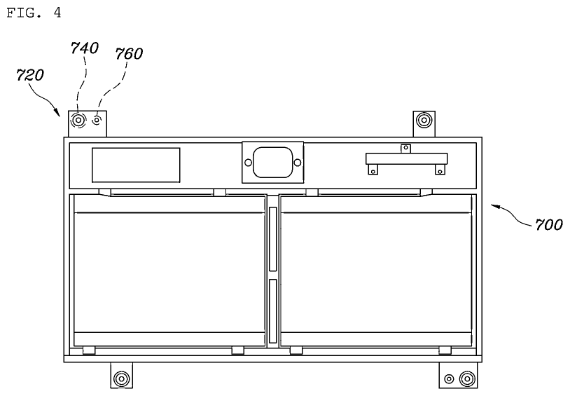

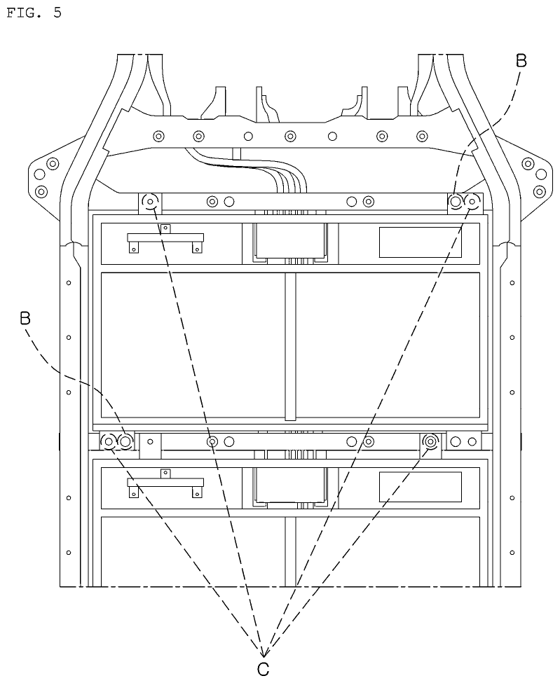

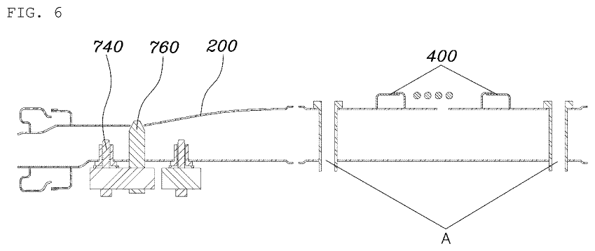

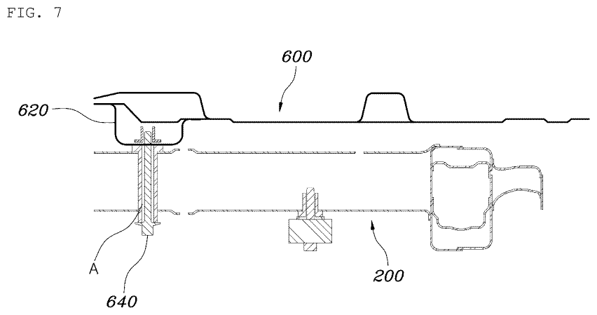

FIG. 1 is a view illustrating a chassis frame according to an embodiment of the present disclosure. FIG. 2 is a view illustrating a state in which a battery is fastened to a vehicle body when viewed from the bottom side. FIG. 3 is a view illustrating a state in which a vehicle body and a chassis frame according to the embodiment of the present disclosure are fastened. FIG. 4 is a view illustrating a battery according to the embodiment of the present disclosure. FIG. 5 is a view illustrating a state in which a battery is installed on a chassis frame according to the embodiment of the present disclosure when viewed from the bottom side. FIG. 6 is a view illustrating a cross-section of a cross member to which a battery according to the embodiment of the present disclosure is fastened. FIG. 7 is a view illustrating a cross-section of a cross member fastened to a reinforcement member by a penetration bolt according to the embodiment of the present disclosure.

A vehicle body assembly for a vehicle according to an embodiment of the present disclosure is described with reference to FIGS. 1, 2, and 3.

FIG. 1 is a view of a chassis frame according to the embodiment of the present disclosure.

Front side members 100 and rear side members 500 are respectively connected to front and rear ends of side members 300 disposed at two opposite sides of the chassis frame. Cross members 200 are connected to the side members 300 while penetrating the side members. In an example, a pair of the cross members 200 extend between and connect the side members 300 and are spaced apart in a forward/rearward direction and define an installation space having an approximately quadrangular shape. A battery 700 may be installed in the installation space. The battery is installed by being inserted into the space defined by the cross members 200 and side members 300 such that the battery may be effectively protected from a collision of the vehicle or the like, a lowest ground clearance of the vehicle may be easily realized, and a seating space of the vehicle may be further expanded downward.

Meanwhile, the battery 700 may be coupled to the cross members 200 by means of brackets 720 carried on two opposite sides and directed or extending toward the cross members. Further, the battery 700 is designed to be separated from the cross members 200 such that the battery may be easily replaced later. In the related art, in order to secure or enhance structural rigidity for collisions or the like, a battery is fastened to the extent that the battery is hardly separable or difficult to separate from the vehicle body. However, in the present disclosure, because the rigidity is realized because the battery 700 is surrounded by the structural members 200 and 300, the battery may be coupled to be fastened to/separated from the vehicle body, thereby implementing convenience of use and extensibility.

Further, the plurality of cross members 200 is spaced apart from one another at equal intervals, such that a plurality of installation spaces having the same shape may be defined. In the case that the installation spaces have the same shape, the batteries 700 mounted in the installation spaces may also have the same corresponding shape. Therefore, the batteries may be standardized and normalized, and the batteries may be changed even in the case of different types of vehicles. Further, there may not be physical limitations to implementing a battery swapping function in the future.

Meanwhile, the batteries and the vehicle need to be connected electrically and connected through a cooling medium. To this end, the vehicle body requires a connector be connected to the batteries. A connection line 440 is connected to one side of a connector 420, and a battery connection part is positioned at the other side of the connector 420. The connector 420 is connected to the vehicle through the connection line 440. The connection line 440 may include various lines. Examples of the connection line 440 may include an electric power line for transmitting or receiving electric power, a communication line for transmitting or receiving data, and a cooling line for transmitting or receiving a cooling medium.

The connector 420 is installed over the cross member 200 and rails 400 without being fastened to the vehicle body. With the above-mentioned configuration, the connector 420 may be securely coupled. Therefore, the rigidity of the electric connection may be ensured, a battery fire or the like may be prevented in the event of an accident, and the electric connection may not be loosened even by frequent replacement, thereby ensuring durability. Of course, the connector 420 may be installed by being coupled to any one of or both the cross member 200 and the rail 400.

Further, the connector 420 is positioned in the installation space in which the battery 700 is installed, such that the connector, together with the battery, may be protected by the peripheral members.

In the battery connection part of the connector 420 is directed toward a lower side of the vehicle, such that the battery 700 may be easily connected to the connector in the case that the battery is fastened to the lower side of the vehicle. In the present disclosure, the structure for fixing the battery 700 is also provided on the premise that the battery is fastened to the lower side of the vehicle. Therefore, the battery may be loaded and connected at once by installing the connector in a proper direction.

The rails 400 for protecting the connector 420 and the connection lines 440 are provided as a pair of rails 400 spaced apart from each other. The rails 400 extend from the outermost peripheral cross member 200 adjacent to the front side members 100 to a point at which the last connector 420 is disposed. The pair of rails 400 is coupled to and supports the plurality of cross members 200, and a protection space is defined between the pair of rails. The rails protect the lines 440 connected to the batteries 700. The pair of rails 400 may be elongated to protect all the plurality of connection lines 440.

Specifically, a plurality of sets of connection lines 440, each including a cable or hose connected to a battery is introduced through the outermost peripheral cross member 200 and extends along the protection space. The sets of connection lines 440 are each connected to each of the corresponding connectors 420 of the batteries. The connector 420, which has one side connected to the connection lines 440 and the other side connected to the battery 700, is coupled to all the rails 400 and the cross members 200 and installed in the installation space. The battery connection part of the connector 420 is directed downward.

For example, assuming that three batteries are mounted in the vehicle body, three sets of connection lines are introduced through the outermost peripheral cross member 200. The connection lines of the sets are sequentially connected to the corresponding connectors of the batteries. Therefore, when only one set of connection lines 440 passes between the rails 400 and the last set of connection lines is connected to the last connector 420, the connection is completed. The rails 400 also extend only to the corresponding last connector 420. With the above-mentioned structure, the plurality of sets of connection lines 440 is protected only by the pair of rails 400. The lengths of the rails 400 may be optimally designed, such that an unnecessary weight may be eliminated.

FIG. 2 is a view illustrating a state in which the battery 700 is fastened to the vehicle body when viewed from the bottom side. A structure in which the vehicle body and the battery are coupled is described with reference to FIG. 2.

The cross members 200, which are spaced apart along the side members 300 of the vehicle body at a predetermined interval and connected to the side members 300, define the installation space, and a battery 700 is installed in each of the installation spaces.

With the above-mentioned structure, the batteries may be protected by the side members 300 and the cross members 200, such that the batteries may be effectively protected from an external collision or impact.

In addition, the rails 400 are provided as a pair of rails 400 spaced apart from each other. The protection space is defined between the pair of rails, and the connection lines 440 are disposed in the protection space.

With the above-mentioned structure, the connection lines 440, which connect the batteries 700 and the vehicle, may be disposed in the protection space, such that the connection lines may be effectively protected from an external collision or impact. The connection lines 440 may be prevented from being disconnected.

Meanwhile, the connectors 420 are provided in the protection space between the pair of rails 400. The battery connection part of each connector 420 is positioned in the corresponding installation space surrounded by the side members 300 and the cross members 200. The battery connection part is directed downward.

With the above-mentioned structure, the connector 420 may be protected by the rails 400, the cross members 200, and the side members 300. Also, the batteries 700 and the connection lines 440 of the vehicle may be prevented from being suddenly disconnected and separated by an external collision or impact.

Meanwhile, penetration bolts 640 are disposed at two opposite points on the rails 400 so that penetration bolts 640 are each provided for each of the cross members 200 and disposed between the pair of rails 400.

With the above-mentioned structure, the rails 400 may be protected from an external collision or impact and the connection lines 440 disposed in the protection space may be additionally protected. Therefore, additionally, the connection lines 440 may be prevented from being disconnected. In addition, the penetration bolts 640, which are disposed for each of the cross members 200, may additionally provide rigidity to the cross member 200 and additionally protect the battery disposed in each of the installation spaces. Therefore, the batteries may be additionally protected.

FIG. 3 is a view illustrating a state in which the vehicle body and the chassis frame according to the embodiment of the present disclosure are fastened. A structure in which reinforcement members 620 of the vehicle body and the cross members 200 of the chassis frame are coupled is described with reference to FIG. 3.

A pair of spaced reinforcement members 620 is disposed on a floor panel of the vehicle body and extends in a length direction of the vehicle. The reinforcement members 620 of the vehicle body are fastened to the plurality of cross members 200 of the chassis frame (B). With the above-mentioned structure, the reinforcement members 620 may be connected to the cross members and support the cross members, thereby improving the rigidity of the cross members and the rigidity of the chassis frame.

FIG. 4 is a view illustrating the battery according to the embodiment of the present disclosure. A shape of the battery 700 according to the embodiment of the present disclosure is described with reference to FIG. 4.

A vehicle connection part is provided at a central portion of an upper end of the battery 700 and connected to the battery connection part of the connector 420. A pair of brackets 720 is provided at two opposite surfaces and fastened to the cross members 200. One of the pair of brackets 720 has a pin 760 inserted into the cross member. The brackets 720 having the pins 760 are disposed in a staggered manner on two opposite surfaces of the battery 700. In order to fasten the battery while loading the battery upward from below the vehicle, it is necessary to accurately guide the battery to a point at which the battery needs to be positioned. To this end, some of the brackets 720 of the battery 700 has the pin 760. The pin 760 is inserted into a hole formed at a vehicle body side at the time of loading the battery, thereby guiding the coupling position of the battery. The pins 760 are formed in a staggered manner along an oblique line on the battery 700, such that the quadrangular battery may be guided only by the two pins.

FIG. 5 is a view illustrating a state in which the battery is installed on the chassis frame according to the embodiment of the present disclosure when viewed from the bottom side. A state in which the battery 700 is installed on the chassis frame of the vehicle body assembly for a vehicle according to the embodiment of the present disclosure is described with reference to FIG. 5.

The battery 700 is fastened at points C on the adjacent cross members 200 at two opposite sides by means of a fastening mechanism 740 provided on the brackets 720 of the battery. The pins 760 formed on the brackets of the battery are inserted at other points B on the adjacent cross members 200 at two opposite sides of the battery. In this case, the points B at which the pins 760 are inserted are positioned on the adjacent cross members 200 in a staggered manner. With the above-mentioned structure, the battery may be more stably coupled to the cross members and installed in the installation space.

FIG. 6 is a view illustrating a cross-section of the cross member 200 to which the battery 700 according to the embodiment of the present disclosure is fastened. A method of fastening the battery and the cross member of the vehicle body assembly for a vehicle according to the embodiment of the present disclosure is described with reference to FIG. 6.

An end of the pin 760 formed on the bracket 720 of the battery 700 is exposed to an upper end of the cross member 200 in a state in which the pin 760 penetrates the cross member 200. With the above-mentioned structure, the pin 760 is inserted while coming into contact with the point B positioned on the cross member and guides the fastening mechanism 740 to a correct position first, prior to the fastening mechanism 740. Thereafter, the fastening mechanism 740 is fastened, such that the battery 700 may be installed at a correct position in the installation space.

FIG. 7 is a view illustrating a cross-section of the cross member fastened to the reinforcement member by means of the penetration bolt according to the embodiment of the present disclosure. A method of fastening the reinforcement member and the cross member of the vehicle body assembly for a vehicle according to the embodiment of the present disclosure is described with reference to FIG. 7.

First, the penetration bolts 640 penetrate the cross member 200 in an upward/downward direction and fasten the cross member 200 and the reinforcement member 620. In addition, as illustrated in FIG. 2, the penetration bolts 640 are disposed at two opposite sides of the rails 400 with the pair of rails 400 interposed therebetween. With the above-mentioned structure, it is possible to prevent contact between battery cells by suppressing a situation in which a central portion of a battery casing is bent downward in the event of a broadside collision of the vehicle. In addition, the penetration bolts 640 may be disposed at two opposite sides of the rails 400, thereby protecting the rails, protecting the connection lines 440 extending to the protection space defined by the rails 400, and preventing the disconnection of the connection lines. Therefore, it is possible to assist in ensuring the stability of the battery.

Meanwhile, the cross member 200 is fastened by the penetration bolt 640. In this case, the penetration bolt 640 penetrates the cross member in the upward/downward direction, and the penetration bolt 640 penetrates a point A of each of cross member provided at two opposite sides of the rails 400 with the pair of rails interposed therebetween. In addition, a height of the penetration bolt 640 is larger than a height of the cross member 200, i.e., the battery 700 is higher than a height of the installation space. With the above-mentioned structure, the contact between the cells of the battery installed in the installation space is prevented in the event of a broadside collision of the vehicle. Therefore, it is possible to prevent an accident such as a battery fire. In addition, because the penetration bolts are positioned at two opposite sides of the rails with the rails interposed therebetween, it is possible to protect the rails and the connection lines positioned in the protection space defined by the rails in the event of a broadside collision of the vehicle. Therefore, it is possible to prevent the disconnection or the like of the connection lines and thus prevent a vehicle breakdown or a vehicle fire caused by the disconnection.

It should be appreciated that the detailed description is interpreted as being illustrative in every sense, not restrictive. The scope of the present disclosure should be determined based on the reasonable interpretation of the appended claims, and all of the modifications within the equivalent scope of the present disclosure are within the scope of the present disclosure.

DESCRIPTION OF REFERENCE NUMERALS

| | |
|---|---|
| 100: Front side member | 200: Cross member |
| 300: Side member | 400: Rail |
| 420: Connector | 440: Connection line |
| 620: Reinforcement member | 640: Penetration bolt |
| 700: Battery | 720: Bracket |
| 740: Fastening mechanism | 760: Pin |

What is claimed is:

1. A vehicle body assembly for a vehicle, the vehicle body assembly comprising:
a chassis frame including side members that are disposed at two opposite sides of the vehicle body assembly and that connect front side members and rear side members, one or more cross members that connect the side members, and one or more batteries fastened to the one or more cross members; and
a vehicle body configured to define an interior space of a vehicle, the vehicle body coupled to an upper portion of the chassis frame and including a floor panel and one or more reinforcement members provided on the floor panel and extending in a length direction of the vehicle body assembly, the reinforcement member being fastened to the one or more cross members.

2. The vehicle body assembly of claim 1, wherein:
the one or more cross members includes a plurality of cross members disposed to be spaced apart from one another in the length direction of the vehicle body assembly;
a pair of the plurality of cross members adjacent to the side members defines an installation space;
the installation space is provided as a plurality of installation spaces formed in the length direction of the vehicle; and
the one or more batteries includes a plurality of batteries respectively inserted into the installation spaces and fastened to the plurality of cross members.

3. The vehicle body assembly of claim 2, wherein the plurality of cross members is spaced apart from one another at equal distances, wherein the plurality of installation spaces has the same shape, and wherein the plurality of batteries has the same shape.

4. The vehicle body assembly of claim 1, further comprising:
one or more rails extending in the length direction of the vehicle body assembly, fastened to and supported by the one or more cross members, and configured to protect a connection line by covering the connection line, wherein the connection line includes a cable or hose connected to a battery of the one or more batteries.

5. The vehicle body assembly of claim 4, wherein the one or more rails includes a pair of rails spaced apart from each other, wherein a protection space is formed between the pair of rails, and wherein the connection line is disposed in the protection space.

6. The vehicle body assembly of claim 4, further comprising:
a connector installed on the one or more rails or the one or more cross members and having one side connected to the connection line and another side connected to a battery of the one or more batteries.

7. The vehicle body assembly of claim 4, further comprising:
a connector provided in a protection space between a pair of the one or more rails and having one side connected to the connection line and another side connected to the battery.

8. The vehicle body assembly of claim 7, wherein a battery connection part is formed at the other side of the connector, and wherein the battery connection part is directed downward so that a battery of the one or more batteries is fastened to the connector in a direction from a lower side toward an upper side.

9. The vehicle body assembly of claim 7, wherein the connector includes a plurality of connectors each disposed respectively for each of a plurality of installation spaces,
wherein the connection line includes sets of connection lines introduced through a cross member of the one or more cross members at an outermost periphery, and
wherein the sets of connection lines each extend along the one or more rails and are each connected to the corresponding connector of the plurality of connectors.

10. The vehicle body assembly of claim 9, wherein the one or more ails extends along the sets of connection lines from the cross member at the outermost periphery, through which the sets of connection lines are introduced, to a point at which a last connector of the plurality of connectors is disposed.

11. The vehicle body assembly of claim 1, wherein a pair of brackets, each having a fastening mechanism, is provided on two opposite surfaces of a battery of the one or more batteries and is directed toward a cross member of the one or more cross members of the one or more batteries, and wherein one bracket of the pair of brackets has a pin inserted into the cross member.

12. The vehicle body assembly of claim 11, wherein brackets having the pins of the battery are disposed in a staggered manner on two opposite surfaces of the battery.

13. The vehicle body assembly of claim 1, wherein a pin is respectively disposed on each of the one or more batteries, a corresponding hole is formed in each of the one or more cross members, and an end of each pin is exposed respectively to an upper end of the one or more cross members in a state in which each pin respectively penetrates the one or more cross members.

14. The vehicle body assembly of claim 1, wherein the one or more cross members are fastened to the reinforcement member by means of one or more penetration bolts that correspondingly penetrate the one or more cross members in an upward/downward direction.

15. The vehicle body assembly of claim 14, wherein:
the one or more cross fastened to the reinforcement member by the one or more penetration bolts; and
the one or more penetration bolts are provided at two opposite sides of the rails with the rails interposed therebetween.
